(19) United States
(12) Patent Application Publication
(10) Pub. No.: US 2026/0163487 A1
(43) Pub. Date: Jun. 11, 2026

(54) BIDIRECTIONAL BUCK-BOOST CONTROLLER

(71) Applicant: Derek Simkowiak, Lynnwood, WA (US)

(72) Inventor: Derek Simkowiak, Lynnwood, WA (US)

(73) Assignee: Holding Zero, LLC, Albuquerque, NM (US)

(21) Appl. No.: 19/321,723

(22) Filed: Sep. 8, 2025

Related U.S. Application Data
(63) Continuation-in-part of application No. 18/349,767, filed on Jul. 10, 2023, now abandoned.
(60) Provisional application No. 63/359,254, filed on Jul. 8, 2022.

(51) Int. Cl. H02M 3/158; H02M 1/00; H02M 1/32; H02M 1/38

(52) U.S. Cl. CPC H02M 3/1582; H02M 1/0009; H02M 1/0058; H02M 1/32; H02M 1/385

(57) ABSTRACT

The bidirectional synchronous soft-switching DC-to-DC buck-boost controller of the present disclosure provides the ability to control electronic switches for synchronous voltage rectification on both electrical sides of the regulator (the high-voltage side and the low-voltage side). This allows the controller to use carefully-timed switches, in conjunction with other circuit components such as inductors and capacitors, to regulate energy flow. The controller also has the ability to sense voltage on both of the electrical sides of the regulator. This allows the controller to determine the optimal switching rate for a given operating mode via an algorithm. The algorithm is executed electronically using a central processing unit (CPU), an application-specific integrated circuit (ASIC), a field-programmable gate array (FPGA), a parallel processor, or other appropriate means.

### CROSS-REFERENCE TO RELATED APPLICATIONS

This application is a continuation-in-part of U.S. patent application Ser. No. 18/349,767, filed on Jul. 10, 2023, and claims the benefit of U.S. Provisional Patent Application Ser. No. 63/359,254 filed Jul. 8, 2022. Contents of the applications are incorporated herein by reference in their entireties.

### TECHNICAL FIELD

The present disclosure relates to a novel bidirectional buck-boost controller for use in direct current (DC) DC-to-DC voltage conversion. More particularly, the present disclosure relates to structural, electrical, and operational aspects of the bidirectional buck-boost controller.

### BACKGROUND ART

Modern technology devices which utilize electricity must manage energy flow. This is done by various electrical circuits and components, including voltage regulators, as would be known to a person having ordinary skill in the art. Said voltage regulators include, but are not limited to, components such as linear regulators, low-dropout regulators (LDOs), and buck-boost regulators.

Of the buck-boost regulators, a switching controller is a well-known component. The controller can be connected in a variety of circuit configurations. Depending on the features of the circuit, the controller can be bidirectional (allowing energy flow in both directions), synchronous (which utilizes switches instead of Schottky diodes), and soft-switching (which uses careful switch timing to improve efficiency). Switching controllers must use a switch dead time to prevent a direct short from supply to ground, known as shoot-through, and may use fixed-frequency switching or simple load-adaptive schemes that generally do not optimize across continuously variable operating conditions. Zero Voltage Switching (ZVS) may be implemented to reduce heat and switching losses. Switching controllers use sensors such as analog-to-digital converters (ADCs) or Hall-effect sensors, which must be calibrated for sensor offset and circuit thermal characteristics to prevent switch timing errors.

The present disclosure provides a novel bidirectional synchronous soft-switching DC-to-DC buck-boost controller that has an output voltage magnitude that is either greater than or less than the input voltage magnitude. The controller of the present disclosure can be used in any application where a DC voltage level conversion is necessary, including, but not limited to, management of battery charging or discharging, mobile technologies, energy harvesting, power optimization, or power management integrated circuit (PMIC) applications.

None of the prior art fully addresses the problems resolved by the present invention. The present invention overcomes these limitations contained in the prior art.

Certain embodiments of the invention have other steps or elements in addition to or in place of those mentioned above. The steps or element will become apparent to those skilled in the art from a reading of the following detailed description when taken with reference to the accompanying figures, if any.

### BRIEF DESCRIPTION OF THE SEVERAL VIEWS OF THE DRAWINGS

FIG. 1 illustrates a top-down view of the bidirectional buck-boost controller, according to certain embodiments of the invention.

FIG. 2 illustrates a method of operating the bidirectional buck-boost controller, according to certain embodiments of the invention.

### DETAILED DESCRIPTION OF THE INVENTION

The best mode for carrying out the invention will be described herein. The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. To avoid obscuring the present invention, some well-known system configurations, and process steps are not disclosed in detail. The figures illustrating embodiments of the system, if any, are semi-diagrammatic and not to scale and, particularly, some of the dimensions are for the clarity of presentation and are shown exaggerated in the drawing figures.

Alternate embodiments have been included throughout, and the order of such are not intended to have any other significance or provide limitations for the present invention.

For expository purposes, the term “horizontal” as used herein is defined as a plane parallel to the plane or surface of the present apparatus, regardless of its orientation. The term “vertical” refers to a direction perpendicular to the horizontal as just defined. Terms, such as “above”, “below”, “bottom”, “top”, “side”, “higher”, “lower”, “upper”, “over”, and “under”, are defined with respect to the horizontal plane, as shown in the figures, if any. The term “on” means that there is direct contact among elements.

The words “including”, “comprising”, “incorporating”, “consisting of”, “have”, and “is” are meant to be non-exclusive, meaning additional items, components or elements may be present. Joinder references such as “connected”, “connecting”, and “coupled” do not limit the position, orientation, or use of systems and/or methods, and do not necessarily infer that two elements are directly connected. All identifying numerical terms are for identification only, and do not refer to the order or preference of any element, embodiment, variation and/or modification.

The present disclosure provides a bidirectional synchronous soft-switching DC-to-DC buck-boost controller comprising a means for controlling one or more high-voltage side switches for synchronous rectification; a means for controlling one or more low-voltage side switches for synchronous rectification; a means for sensing voltage on the high-voltage side; a means for sensing voltage on the low-voltage side; a means for executing an algorithm; a switching algorithm to determine an optimized switching rate for a given operating mode; a means to vary the switching rate to any value within a predefined range, in real time; and a means for varying the operating mode.

The bidirectional synchronous soft-switching DC-to-DC buck-boost controller of the present invention further comprising: wherein the means of controlling a switch on either the high voltage side or the low voltage side comprises a voltage signal connected to a pulse-width modulation timer; wherein the means of sensing a voltage on either the high voltage side or the low voltage side comprises an analog-to-digital converter connected to a voltage sensor circuit; a means for sensing temperature; wherein the means of sensing temperature is an analog-to-digital converter connected to a temperature sensor circuit; wherein the temperature sensor circuit comprises a thermistor; a means for sensing electrical current on any of the high voltage side and/or the low voltage side; wherein the means of sensing electrical current comprises an analog-to-digital converter connected to a current sensor circuit; electrical switches for synchronous rectification; wherein the electrical switches are metal-oxide-semiconductor field-effect transistors (MOSFETs); wherein one or more means are comprised of discrete electrical components; wherein one or more means are contiguous within an integrated circuit; a means for power path control such that the high side can be electrically disconnected from the low side; wherein the means for power path control is a MOSFET; one or more data buses, including, but not limited to, an Inter-Integrated Circuit (IIC) compatible data bus; a means to communicate values including, but not limited to, voltage, amperage, and temperature, using the data buses; wherein said switching algorithm uses real-time load demand and measured input voltage fluctuations to determine an optimized switching frequency to improve efficiency at both high and low loads, reducing losses in power conversion. Said switching algorithm implements predictive ZVS, wherein it predicts when drain-source voltage (Vds) will cross zero based on inductor current, load, and circuit resonance, then schedules the gate drive accordingly, such that it not just prevents switch on-time overlap, but improves switching efficiency to greater than 85% efficient across a load range of 30% to 100% of rated output power. Said switching algorithm implements dynamic dead-time optimization, which measures real-time operating conditions (voltage, amperage, temperature) to adjust the dead time to within 10 microseconds the minimum safe value at that moment. The bidirectional synchronous soft-switching DC-to-DC buck-boost controller of the present invention further comprising a means for self-calibrating current sensing with temperature drift compensation, wherein the controller periodically enters a calibration mode where known load steps are applied to measure sensor offset and gain errors, such that current sensor offset and thermal drift are compensated for within 10% of actual values, improving long-term accuracy in high-reliability applications.

In certain embodiments, one or more means are comprised of discrete electrical components for configurations supporting greater than approximately 6 Amps of continuous current. Such discrete-component implementations allow for increased heat dissipation through individual device packages and greater physical separation of high-current paths, thereby enabling higher sustained current operation without excessive thermal stress. In other embodiments, one or more means are contiguous within an integrated circuit for configurations supporting less than approximately 6 Amps of continuous current. Integrated-circuit implementations reduce parasitic inductance and minimize interconnect length between functional blocks, improving high-frequency switching performance and efficiency in lower-current applications. The threshold of approximately 6 Amps is given by way of example and may vary depending on thermal management capability, package technology, and efficiency targets for a given application.

In one embodiment, the buck-boost controller includes a temperature sensor circuit comprising a thermistor thermally coupled to the high-voltage side switches.

The controller algorithm uses the temperature information from the thermistor to adjust the switching rate of the high-voltage and low-voltage side switches.

The algorithm is configured such that the switch temperature is maintained within ±5° C. of a target setpoint under all load conditions. By regulating the switching rate in this manner, the controller reduces switching losses, maintains high efficiency (e.g., greater than 85%), and prevents thermal overstress of the switches during operation. This control strategy ensures precise thermal management and stable performance across varying operating modes and load conditions.

The present disclosure further provides a method of operating a buck-boost controller, the method comprising sending a signal to indicate operating mode; optionally, also sending parameters for use in an algorithm; reading external inputs, such as voltage, amperage, and temperature; computing an algorithm to determine buck-boost switching rate based on input parameters; and controlling one or more switches for synchronous rectification.

The present disclosure provides a bidirectional synchronous soft-switching DC-to-DC buck-boost controller that comprises a means for controlling electronic switches for synchronous voltage rectification on both electrical sides of the regulator (the high-voltage side and the low-voltage side). This allows the controller to use timed switches, in conjunction with other circuit components such as inductors and capacitors, to regulate energy flow.

The controller of the present disclosure also comprises a means for sensing voltage on both of said sides. This allows the controller to determine the optimal switching rate for a given operating mode via an algorithm. Said switching algorithm is executed electronically using a means such as, but not limited to, a central processing unit (CPU), an application-specific integrated circuit (ASIC), a field-programmable gate array (FPGA), or a parallel processor.

The switching rate of the controller of the present disclosure is not limited to a fixed set of predefined values, but instead can be an optimal rate within a predefined range. Said switching algorithm can adjust the switching rate in real time, or halt energy transfer altogether, depending on the current operating mode.

The controller of the present disclosure supports one or more operating modes. For example, battery-related applications may include charge-under-load mode, ship mode, standby mode, over/under voltage protection mode, and other modes of operation. Said switching algorithm uses the operating mode to determine the current switching rate, thus controlling the flow of energy. The operating mode selection method includes, but is not limited to, static configuration (such as a resistor value or digital signal), a software configuration, or by an external input via a communication bus.

Details to specific aspects or features of the present inventions are described below. Certain examples are illustrated in the accompanying drawings. Corresponding reference numbers will be used throughout the drawings to refer to the same or corresponding parts.

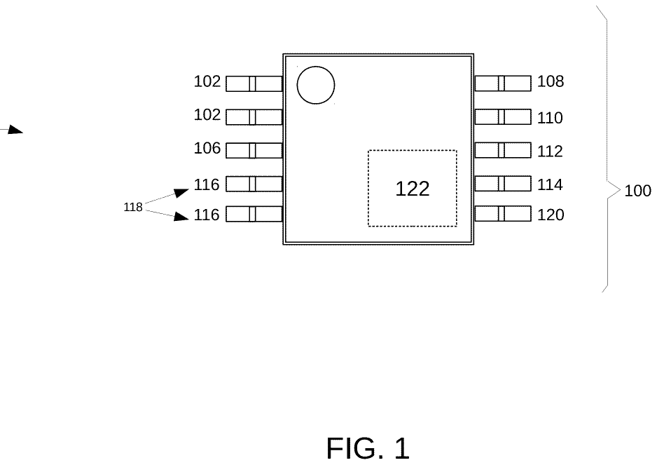

FIG. 1 illustrates a top view of the bidirectional buck-boost controller 100, according to certain embodiments of the invention. There are two pulse-width modulation timers which control switches 102, which are used synchronously to control energy flow. An ADC connected to a temperature sensor circuit 106 allows temperature to be used as an input to said switching algorithm, which is executed on CPU 122, and which may be reported via communication bus 116. ADCs connected to a voltage sensor circuit allow for sensing voltage on both the high side 108 and low side 110 of said controller, such that said voltages may be reported via the communication bus 118, and also used as an input to said switching algorithm. Separately, ADCs connected to a current sensor circuit on the high side 112 and low side 114 measure current, which may be reported via the communication bus 118, and also integrated over time such that energy flow can be optimized for the current operating mode. The controller 100 has a ground connector 120 for operation in an electrical circuit.

In certain embodiments, there maybe be one or more pulse-width modulation timers which control switches 102 to support operating modes including, but not limited to, half-bridge and full-bridge modes.

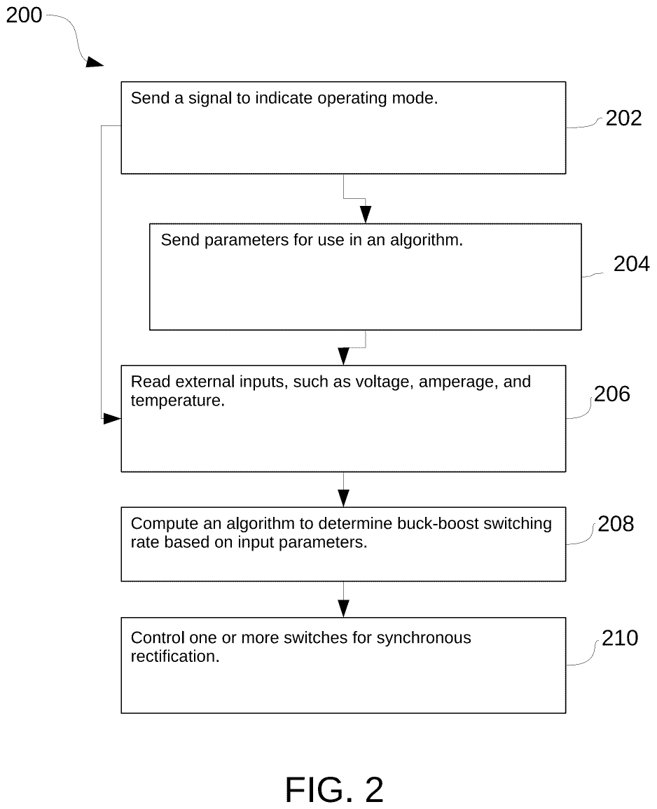

FIG. 2 illustrates a method 200 of operating a buck-boost controller, according to certain embodiments. According to method 200, at step 202 a signal is sent to indicate operating mode. Optionally, at step 204 additional input parameters may be input to said switching algorithm. Step 206 reads external inputs, such as voltage, amperage, and temperature, as inputs for said switching algorithm. Step 208 computes an algorithm to determine buck-boost switching rate based on input parameters. Step 210 controls one or more switches for synchronous rectification.

In certain embodiments, step 206 may be omitted, and said switching algorithm may determine said buck-boost switching rate directly.

The best mode for carrying out the invention has been described herein. The previous embodiments are described in sufficient detail to enable those skilled in the art to make and use the invention. It is to be understood that other embodiments would be evident based on the present disclosure, and that system, process, or mechanical changes may be made without departing from the scope of the present invention.

In the previous description, numerous specific details and examples are given to provide a thorough understanding of the invention. However, it will be apparent that the invention may be practiced without these specific details and specific examples. While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations that fall within the scope of the included claims. All matters previously set forth herein or shown in the accompanying figures are to be interpreted in an illustrative and non-limiting sense.

### LIST OF ELEMENTS SHOWN ON THE DRAWINGS

100 Bidirectional buck-boost controller
102 Pulse-width modulation timer connected to a switch
106 Analog-to-digital converter connected to a temperature sensor circuit
108 Analog-to-digital converter connected to a high-side voltage sensor circuit
110 Analog-to-digital converter connected to a low-side voltage sensor circuit
112 Analog-to-digital converter connected to a high-side current sensor circuit
114 Analog-to-digital converter connected to a low-side current sensor circuit
116 Communication bus connector
118 Communication bus
120 Ground connector
122 Central processing unit
200 Method
202 Step
204 Step
206 Step
208 Step
210 Step

1. A bidirectional synchronous soft-switching DC-to-DC buck-boost controller comprising:
a means for controlling one or more high-voltage side switches for synchronous rectification;
a means for controlling one or more low-voltage side switches for synchronous rectification;
a means for sensing voltage on the high-voltage side;
a means for sensing voltage on the low-voltage side;
a means for executing an algorithm;
a switching algorithm to determine an optimized switching rate for a given operating mode, wherein said switching algorithm dynamically adjusts the switching frequency based on real-time load demand and input voltage fluctuations,
wherein said switching algorithm performs predictive ZVS, such that it predicts when drain-source voltage (Vds) will cross zero based on inductor current, load, and circuit resonance, such that switching efficiency is greater than 85% across a load range of 30% to 100% of rated output power,
wherein said switching algorithm performs dynamic dead-time optimization, wherein it uses real-time operating conditions (voltage, amperage, temperature) to adjust the dead time to within 10 microseconds of the minimum safe value;
a means for self-calibrating current sensing with temperature drift compensation,
wherein known load steps are applied to measure sensor offset and gain errors, such that current sensor offset and thermal drift are compensated for within 10% of actual values;
a means to vary the switching rate to any value within a predefined range, in real time; and
a means for varying the operating mode.

2. The buck-boost controller of claim 1, wherein the means of controlling a switch on either the high voltage side or the low voltage side comprises a voltage signal connected to a pulse-width modulation timer.

3. The buck-boost controller of claim 1, wherein the means for sensing voltage on the high-voltage side or the low-voltage side comprises an analog-to-digital converter connected to a voltage sensor circuit.

4. The buck-boost controller of claim 1, further comprising a means for sensing temperature.

5. The buck-boost controller of claim 4, wherein the means of sensing temperature is an analog-to-digital converter connected to a temperature sensor circuit.

6. The buck-boost controller of claim 5, wherein the temperature sensor circuit comprises a thermistor thermally coupled to the high-voltage side switches, the thermistor configured to regulate the switching rate to limit the maximum switch temperature to a predefined threshold, wherein the temperature is maintained within ±5° C. of a target setpoint under all load conditions.

7. The buck-boost controller of claim 1, further comprising a means for sensing electrical current on any of the high voltage side and/or the low voltage side.

8. The buck-boost controller of claim 7, wherein the means for sensing electrical current comprises an analog-to-digital converter connected to a current sensor circuit.

9. The buck-boost controller of claim 1, wherein each said means is comprised of discrete electrical components for configurations supporting greater than approximately 6 Amps of continuous current, the discrete electrical components being arranged to increase heat dissipation and to permit greater physical separation of high-current paths.

10. The buck-boost controller of claim 1, wherein each said means is contiguous within an integrated circuit for configurations supporting less than approximately 6 Amps of continuous current, the integrated circuit being arranged to reduce parasitic inductance and minimize interconnect length between functional blocks to improve high-frequency switching performance.

11. The buck-boost controller of claim 1, further comprising electrical switches for synchronous rectification.

12. The buck-boost controller of claim 11, wherein the electrical switches are metal-oxide-semiconductor field-effect transistors (MOSFETs).

13. The buck-boost controller of claim 11, wherein each said means is comprised of discrete electrical components for configurations supporting greater than approximately 6 Amps of continuous current, the discrete electrical components being arranged to increase heat dissipation and to permit greater physical separation of high-current paths.

14. The buck-boost controller of claim 11, wherein each said means is contiguous within an integrated circuit for configurations supporting less than approximately 6 Amps of continuous current, the integrated circuit being arranged to reduce parasitic inductance and minimize interconnect length between functional blocks to improve high-frequency switching performance.

15. The buck-boost controller of claim 1, further comprising a means for power path control such that the high side can be electrically disconnected from the low side.

16. The buck-boost controller of claim 15, wherein the means for power path control is a MOSFET.

17. The buck-boost controller of claim 1, further comprising one or more data buses, including, but not limited to, an Inter-Integrated Circuit (IIC) compatible data bus.

18. The buck-boost controller of claim 17, further comprising a means to communicate values including, but not limited to, voltage, amperage, and temperature, using the data buses.

19. The buck-boost controller of claim 1, wherein said switching algorithm uses temperature information from a thermistor thermally coupled to the high-voltage side switches to determine the switching rate, said switching algorithm configured to regulate the switching rate to maintain the switch temperature within ±5° C. of a target setpoint under all load conditions, thereby reducing switching losses and maintaining efficiency above 85%.

20. A method of operating a buck-boost controller, the method comprising:
sending a signal to indicate operating mode, including, but not limited to, self-calibration mode,
wherein optionally the parameters for use in an algorithm may also be sent;
reading external inputs, such as voltage, amperage, and temperature, and applying calibration values to compensate for sensor offsets and temperature drift;
computing an algorithm to determine buck-boost switching rate based on input parameters and calibration values,
wherein said switching algorithm dynamically adjusts switching frequency and dead time in real time and predicts drain-source voltage zero crossings for predictive Zero Voltage Switching; and
controlling one or more switches for synchronous rectification with switching efficiency greater than 85% across a load range of 30% to 100% of rated output power and a switching dead time within 10 microseconds of the minimum safe value for the given operating conditions.
